(19) United States
(12) Patent Application Publication
(10) Pub. No.: US 2026/0221604 A1
(43) Pub. Date: Jul. 30, 2026

(54) FLEXIBLE PRINTED CIRCUIT BOARD MODULE AND BATTERY DEVICE

(71) Applicant: MEKTEC CORPORATION, Tokyo (JP)

(72) Inventors: Kenichi NAKAYAMA, Tokyo (JP); Tomoki KANAYAMA, Tokyo (JP); Shuzo YAMADA, Tokyo (JP); Takamasa SUZUKI, Tokyo (JP)

(73) Assignee: MEKTEC CORPORATION, Tokyo (JP)

(21) Appl. No.: 19/445,077

(22) Filed: Jan. 9, 2026

(30) Foreign Application Priority Data
Jan. 27, 2025 (JP) 2025-011638

(51) Int. Cl. H01M 50/519; H01M 10/48; H01M 50/209; H01M 50/507

(52) U.S. Cl. CPC H01M 50/519; H01M 10/482; H01M 10/486; H01M 50/209; H01M 50/507

(57) ABSTRACT

A flexible printed circuit board module is a flexible printed circuit board module attachable to a battery including a plurality of cells, including: a flexible printed circuit board; a plurality of bus bars; and a case, in which the flexible printed circuit board includes a line, the plurality of bus bars is electrically connected to the line, the flexible printed circuit board and the plurality of bus bars are attached to the case, and the flexible printed circuit board is disposed between the battery and the case.

### CROSS-REFERENCE TO RELATED APPLICATION

This application is based on Japanese Patent Application No. 2025-011638 filed with the Japan Patent Office on Jan. 27, 2025, the entire content of which is hereby incorporated by reference.

### BACKGROUND

### 1. Technical Field

The present disclosure relates to a flexible printed circuit board module and a battery device.

### 2. Related Art

There has been known a technique of providing a flexible printed circuit board module for a battery device including a plurality of cells in order to monitor the voltage of the cell or measure the temperature of the cell in the battery device (JP-A-2024-31083). Hereinafter, a flexible printed circuit board will be referred to as an FPC. Moreover, the flexible printed circuit board module will be referred to as an FPC module. Hereinafter, with reference to FIGS. 13A and 13B, a battery device used in a reference example will be described. FIG. 13A is a plan view of the battery device used in the reference example. FIG. 13B is a bottom view of an FPC module used in the reference example.

The battery device used in the reference example includes a battery 10 including a plurality of cells 11, and an FPC module 500 attached to the upper surface of the battery 10. The FPC module 500 includes an FPC 510. A connector 520 for connection with an external device is attached to one end of the FPC 510. The FPC 510 includes a plurality of lines. Further, a plurality of connection terminals 530 is attached to the FPC 510. Each connection terminal 530 is connected to a corresponding one of the plurality of lines. The FPC module 500 further includes a plurality of bus bars 540 joined to the cells 11, and a case 550 to which the plurality of bus bars 540 and the FPC 510 are attached. In order to attach the plurality of bus bars 540 to the case 550, the case 550 is provided with attachment holes 551. Each bus bar 540 is fixed to a corresponding one of the plurality of connection terminals 530.

The bus bar 540 described above is joined to the cells 11 by welding. In the welding, the bus bar 540 is welded to the cells 11 from the opposite side of the bus bar 540 from the cells 11, for example, by laser welding. When the bus bar 540 and the cells 11 are fixed to each other by welding, sputtering occurs. Thus, the FPC 510 may be damaged due to sputtered particles. For this reason, the FPC module 500 used in the reference example is provided with a cover 560 made of resin or the like. In FIG. 13A, the cover 560 is indicated by a thick line. A hidden portion of the FPC 510 in the plan view is see-through, and is indicated by a dotted line. As seen from this figure, the FPC 510 is covered with the cover 560. Thus, even if the sputtering occurs as described above, collision of the sputtered particles with the FPC 510 is reduced. With the configuration described above, the damage to the FPC 510 due to the sputtered particles can be reduced.

However, in a case where the configuration described above is adopted, the cover 560 is required. For this reason, the number of components increases. In addition, the thickness of the FPC module 500 increases. Further, the weight of the FPC module 500 also increases.

The FPC module 500 may have a function of measuring the temperature of the cell 11 (structure having a thermistor element or the like). In this case, for example, a foldable portion is provided for the case. Such a portion is folded. This allows a structure of pressing the thermistor element toward the cell to be adopted. However, in a case where this structure is adopted, the size of the case further increases.

### SUMMARY

A flexible printed circuit board module according to an embodiment is a flexible printed circuit board module attachable to a battery including a plurality of cells, including: a flexible printed circuit board; a plurality of bus bars; and a case, in which the flexible printed circuit board includes a line, the plurality of bus bars is electrically connected to the line, the flexible printed circuit board and the plurality of bus bars are attached to the case, and the flexible printed circuit board is disposed between the battery and the case.

### BRIEF DESCRIPTION OF DRAWINGS

FIGS. 1A and 1B are schematic views of a battery according to the present embodiment;

FIGS. 2A and 2B are schematic views of a battery device according to a first embodiment;

FIG. 3 is a bottom view of a flexible printed circuit board module according to the first embodiment;

FIGS. 4A and 4B are schematic views of a flexible printed circuit board used in the first embodiment;

FIGS. 5A and 5B are schematic views of a case used in the first embodiment;

FIGS. 6A and 6B are views for comparing the first embodiment and a reference example with each other;

FIGS. 7A and 7B are schematic views of a battery device according to a second embodiment;

FIG. 8 is a bottom view of a flexible printed circuit board module according to the second embodiment;

FIGS. 9A and 9B are schematic views of a flexible printed circuit board according to the second embodiment;

FIGS. 10A and 10B are schematic views of a case used in the second embodiment;

FIG. 11 is a view for describing a reinforcing plate used in the second embodiment;

FIGS. 12A and 12B are schematic views of a flexible printed circuit board module according to a third embodiment; and

FIG. 13A is a plan view of a battery device used in the reference example, and FIG. 13B is a bottom view of an FPC module used in the reference example.

An object of the present embodiment is to provide a flexible printed circuit board module and a battery device, which are configured so that damage to a flexible printed circuit board can be reduced while the number of components and a device size are reduced.

### DETAILED DESCRIPTION

In the following detailed description, for purpose of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

In the present embodiment, the following techniques are adopted in order to solve the problems described above.

That is, a flexible printed circuit board module according to the embodiment is a flexible printed circuit board module attachable to a battery including a plurality of cells, including: a flexible printed circuit board; a plurality of bus bars; and a case, in which the flexible printed circuit board includes a line, the plurality of bus bars is electrically connected to the line, the flexible printed circuit board and the plurality of bus bars are attached to the case, and the flexible printed circuit board is disposed between the battery and the case.

According to the present embodiment, the flexible printed circuit board can be disposed between the battery and the case. The flexible printed circuit board is covered with the case. Thus, even if sputtering occurs when the bus bar is welded to the cells, collision of sputtered particles with the flexible printed circuit board can be reduced by the case.

The case may be provided with a plurality of attachment holes, each of the plurality of bus bars may be fixed to a corresponding one of the plurality of attachment holes, and the flexible printed circuit board may be fixed to the case at a plurality of positions by thermal caulking.

With this configuration, when the flexible printed circuit board module is attached to the battery, even if the flexible printed circuit board is disposed on the lower side of the case, the flexible printed circuit board is neither detached from the case, nor hangs down.

The flexible printed circuit board module further includes a reinforcing plate and a connector. In the flexible printed circuit board module, it may be configured such that the case is formed with an opening, the flexible printed circuit board includes a closure closing the opening, the reinforcing plate is fixed to the case via the flexible printed circuit board while covering the closure, and has a higher strength than that of the flexible printed circuit board, and the connector is disposed in the opening, and is attached to the closure.

With this reinforcing plate, the connector can be properly fixed to the flexible printed circuit board.

A thermistor element that measures a temperature of each cell may be disposed between the case and the flexible printed circuit board.

With this configuration, the thermistor element can be provided with a simple configuration. Thus, the size of the case can be reduced.

A battery device according to the present embodiment includes: a battery having a plurality of cells; and a flexible printed circuit board module attached to the battery, in which the flexible printed circuit board module includes a flexible printed circuit board, a plurality of bus bars and a case, the flexible printed circuit board includes a line, the plurality of bus bars is electrically connected to the line, the flexible printed circuit board and the plurality of bus bars are attached to the case, and the flexible printed circuit board is disposed between the battery and the case.

According to the present embodiment, the flexible printed circuit board can be disposed between the battery and the case. Thus, the flexible printed circuit board is covered with the case. Thus, even if sputtering occurs when the bus bar is welded to the cells, collision of sputtered particles with the flexible printed circuit board can be reduced by the case.

Note that the configurations described above may be adopted in combination to the extent possible.

As described above, according to the present embodiment, the number of components and the device size can be reduced while the damage to the flexible printed circuit board is reduced.

Hereinafter, the present embodiment will be described in detail as an example with reference to the drawings. Note that unless otherwise specified, the dimensions, materials, shapes, relative arrangements, and the like of components described in embodiments are not intended to limit the technical scope of the present embodiment only to those in the description of the embodiments.

### First Embodiment

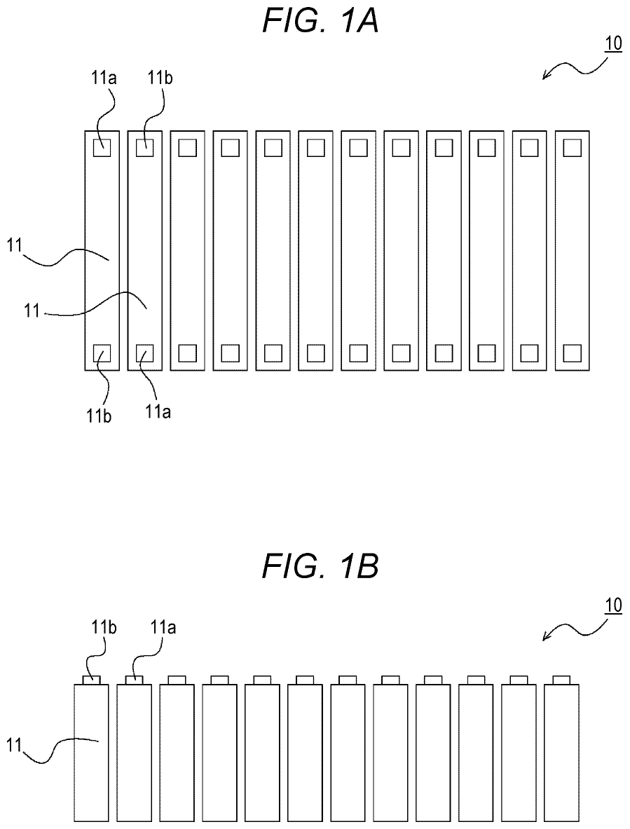

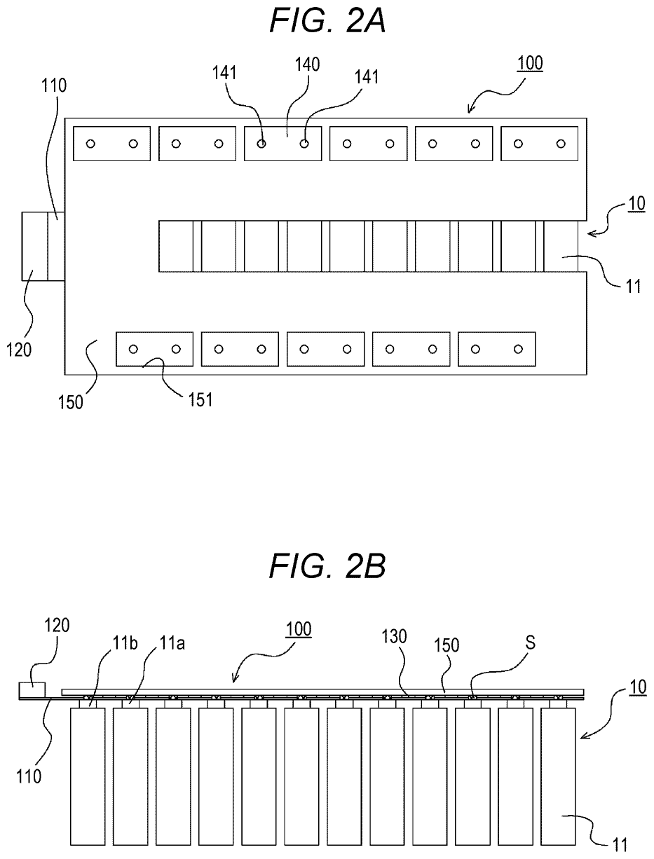

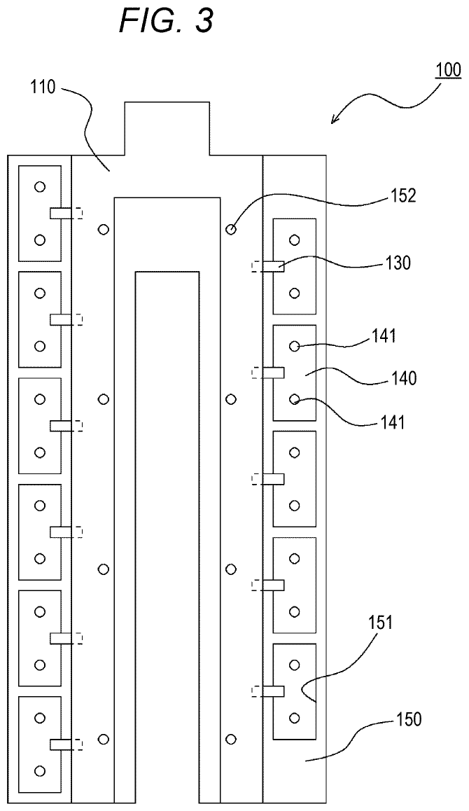

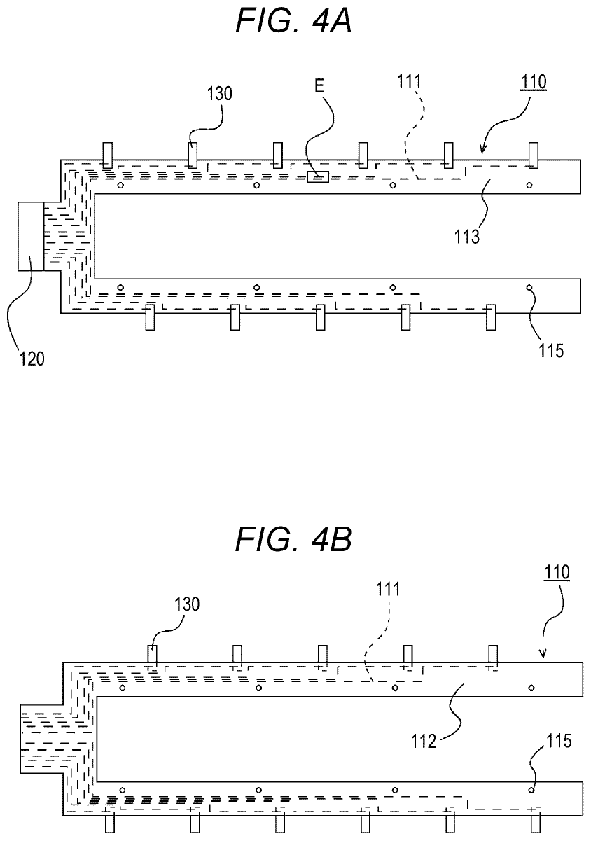

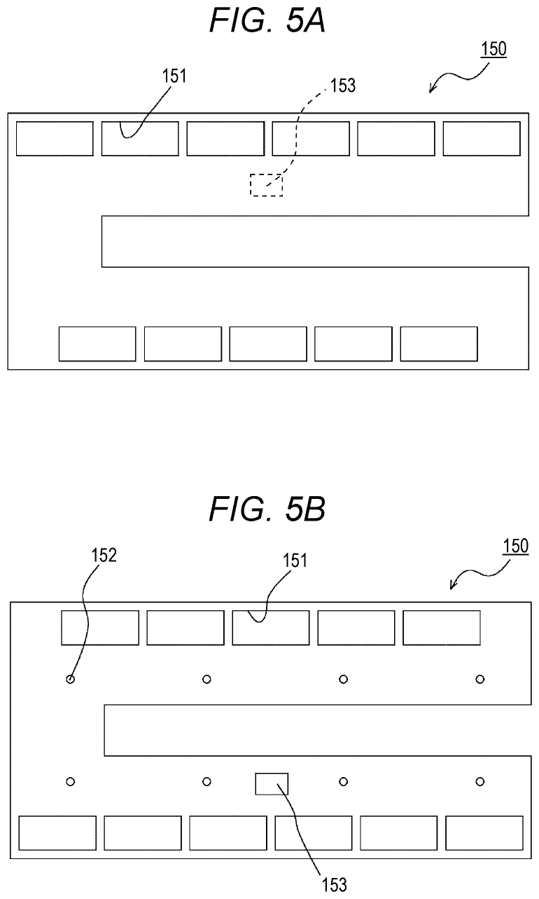

With reference to FIGS. 1A to 5B, a flexible printed circuit board module and a battery device according to a first embodiment will be described. Hereinafter, a flexible printed circuit board will be referred to as an FPC. The flexible printed circuit board module will be referred to as an FPC module. FIGS. 1A and 1B are schematic views of a battery used in the first embodiment. FIG. 1A is a plan view of the battery. FIG. 1B is a side view of the battery. FIGS. 2A and 2B are schematic views of the battery device according to the first embodiment. FIG. 2A is a plan view of the battery device. FIG. 2B is a side view of the battery device. FIG. 3 is a bottom view of the FPC module according to the first embodiment. FIGS. 4A and 4B are schematic views of the FPC used in the first embodiment. FIG. 4A is a plan view of the FPC. FIG. 4B is a bottom view of the FPC. FIGS. 5A and 5B are schematic views of a case used in the first embodiment. FIG. 5A is a plan view of the case. FIG. 5B is a bottom view of the case.

### <Outline of Battery Device>

As shown in FIG. 2B, the battery device includes a battery 10 having a plurality of cells 11, and an FPC module 100 attached to the battery 10. The FPC module 100 is used for monitoring the voltage of the cell 11.

### <Battery>

Each cell 11 forming the battery 10 is provided with an electrode (positive electrode 11a and negative electrode 11b). The plurality of cells 11 is arranged such that the positive electrode 11a and the negative electrode 11b are adjacent to each other (see FIGS. 1A and 1B). Moreover, the plurality of cells 11 is configured such that the positive electrode 11a and the negative electrode 11b adjacent to each other are electrically connected to each other via a bus bar 140 provided for the FPC module 100. In this manner, the battery 10 is configured such that the cells 11 are connected in series.

### <FPC Module>

The FPC module 100 includes an FPC 110. The FPC 110 includes a plurality of lines 111, and resin films (base film 112 and cover film 113) provided on the upper and lower surfaces of the plurality of lines 111. In FIGS. 4A and 4B, the lines 111 are see-through, and are indicated by dotted lines. The FPC 110 itself is a well-known technique. Thus, detailed description thereof will be omitted. First, metal foil (copper foil or the like) on the base film 112 is etched. In this manner, a circuit (lines 111) is formed. Thereafter, the cover film 113 is provided to cover the lines 111. A connector 120 is attached to one end of the FPC 110 configured as described above. A corresponding connection terminal 130 is attached to each of the plurality of lines 111 (see FIGS. 4A and 4B). Note that an opening is provided in part of the cover film 113. With this configuration, the connector 120 and each connection terminal 130 are joined to the lines 111, for example, by soldering. Moreover, the connector 120 is connected to an external device (ECU or the like) for monitoring the voltage of the cell 11.

The FPC module 100 includes a plurality of the bus bars 140 and a resin case 150. The bus bar 140 is indirectly and electrically connected to the line 111 of the FPC 110 via the connection terminal 130. The FPC 110 and the plurality of bus bars 140 are attached to the case 150. The connection terminal 130 and the bus bar 140 are joined to each other, for example, with solder. As described above, the bus bar 140 joins the positive electrode 11a and negative electrode 11b of the cells 11 adjacent to each other. The bus bar 140 and the cells 11 (positive electrode 11a and negative electrode 11b) are joined to each other by welding. In the welding, the bus bar 140 is welded to the cells 11 from the opposite side of the bus bar 140 from the cells 11, for example, by laser welding. S in FIG. 2B indicates a welded portion. In the first embodiment, the bus bar 140 is provided with a through-hole 141 in order to easily recognize a welding position. Note that the through-hole 141 is not necessarily provided.

A plurality of attachment holes 151 is provided in the case 150. The bus bar 140 is fixed in each of these attachment holes 151. A method for fixing the attachment hole 151 and the bus bar 140 to each other is not particularly limited. For example, various well-known techniques such as engagement of an engagement protrusion and an engagement hole may be adopted. The FPC 110 is fixed to the case 150 at a plurality of positions by thermal caulking. In the first embodiment, the case 150 is provided with a plurality of protrusions 152 for the thermal caulking. Further, the FPC 110 is provided with a plurality of insertion holes 115. The protrusion 152 penetrates the insertion hole 115. With this configuration, the thermal caulking can be performed in a state of the protrusion 152 being inserted into the insertion hole 115. In this manner, the FPC 110 can be fixed to the case 150. Note that a reinforcing plate having a higher stiffness than that of the FPC 110 can be bonded to a portion of the FPC 110 on which the thermal caulking is performed. In this manner, the FPC 110 can be more easily fixed to the case 150. Note that the reinforcing plate may be a resin film. Alternatively, the reinforcing plate may be, for example, a less-bendable resin board. A method for fixing the case 150 and the FPC 110 to each other is not limited to the thermal caulking. Various well-known techniques such as fixing with a gluing agent, an adhesive, or a double-sided tape may be adopted.

In the FPC module 100 configured as described above, the plurality of bus bars 140 is joined to the battery 10 (cells 11) by welding in a state in which the FPC 110 fixed to the case 150 faces the battery 10. As described above, in the welding, the bus bars 140 are joined to the battery 10 from the opposite side of the bus bars 140 from the cells 11. That is, the FPC is disposed in a position opposed, across the case 150, to the direction of the welding of the bus bars 140 to the cells 11. As described above, the FPC 110 is disposed between the battery 10 and the case 150.

<Advantages of FPC Module and Battery Device according to First Embodiment>

According to the first embodiment, the FPC 110 is disposed between the battery 10 and the case 150. Thus, the FPC 110 is covered with the case 150 (see FIGS. 2A and 2B). Thus, even if sputtering occurs when the bus bar 140 is welded to the cells 11, collision of sputtered particles with the FPC 110 can be reduced by the case 150. Unlike a general technique, damage to the FPC 110 can be reduced even with no cover. Thus, as compared to the general technique, the number of components can be reduced. Consequently, the thickness of the FPC module 100 can be reduced. Further, the weight thereof can also be reduced. As described above, the number of components and the device size can be reduced while the damage to the FPC 110 is reduced. In the first embodiment, when the FPC module 100 is attached to the battery 10, the FPC 110 faces downward of the case 150. However, the FPC 110 is fixed to the case 150. This prevents the FPC 110 from hanging down.

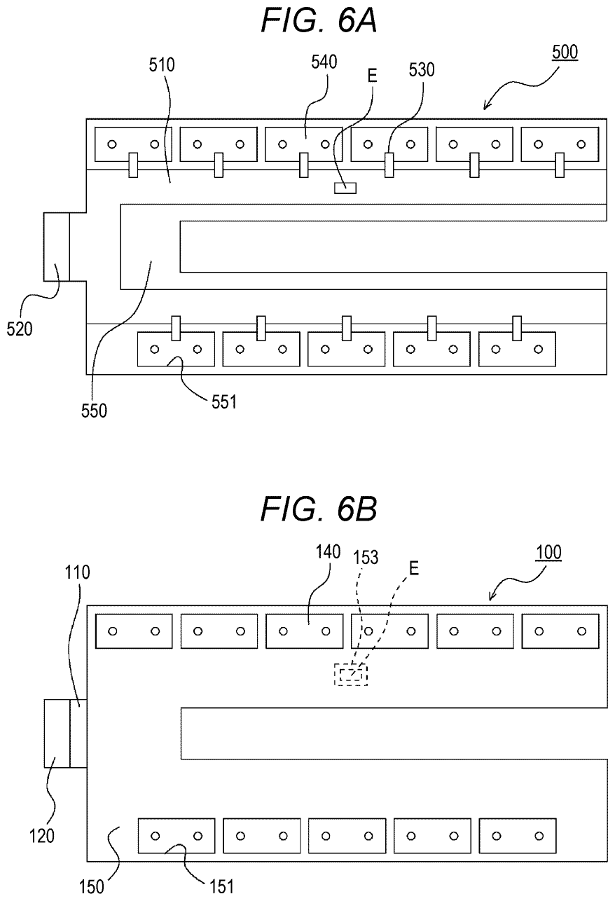

Further, in the first embodiment, adherence of a contaminant, such as dirt or dust, to an electronic component disposed on the FPC can be reduced. This point will be described with reference to FIGS. 6A, 6B, and the like. FIG. 6A is a plan view of an FPC module used in a reference example. In FIG. 6A, a cover is detached. FIG. 6B is a plan view of the FPC module according to the first embodiment. FIGS. 6A and 6B show a state of an electronic component E being attached to the FPC module. As shown in FIG. 6A, in a general technique, the electronic component E disposed on an FPC 510 is exposed. For this reason, even if a cover 560 for covering the FPC 510 is attached, a contaminant enters through a gap between the FPC 510 and the cover 560. As a result, the contaminant adheres to the electronic component E. On the other hand, in the first embodiment, the FPC 110 and the case 150 closely contact each other due to the thermal caulking. Thus, the electronic component E disposed on the FPC 110 is sealed by the FPC 110 and the case 150. Thus, adherence of the contaminant is reduced. Note that FIG. 4A shows the electronic component E attached to the FPC 110. Preferably, the case 150 is provided with a hole 153 for forming a closed space where the electronic component E is disposed (see FIGS. 5A, 5B, and 6B). In this manner, the FPC 110 and the case 150 closely contact each other due to the thermal caulking, and therefore, the electronic component E is disposed in the closed space formed by the hole 153. Thus, adherence of the contaminant to the electronic component E can be more reliably reduced.

### Second Embodiment

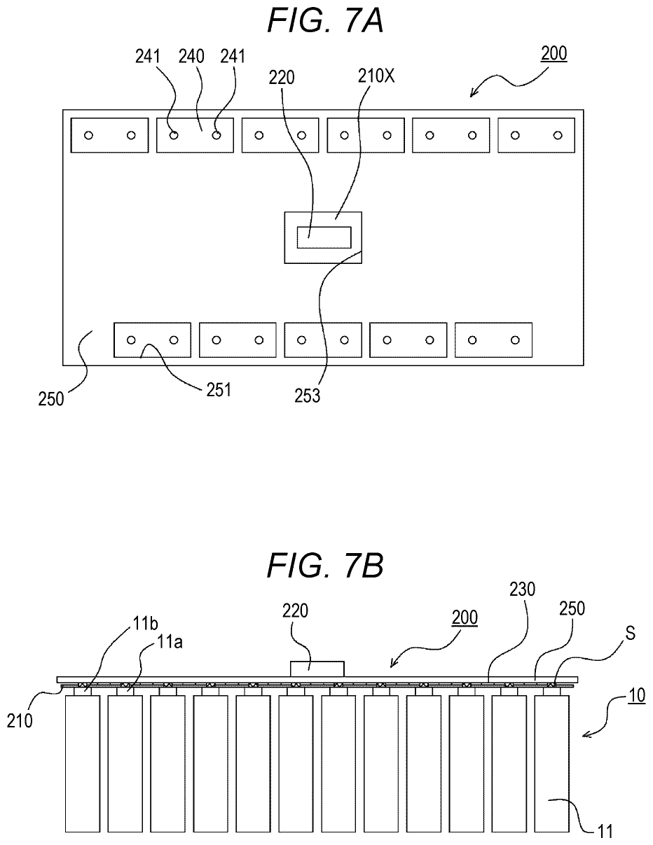

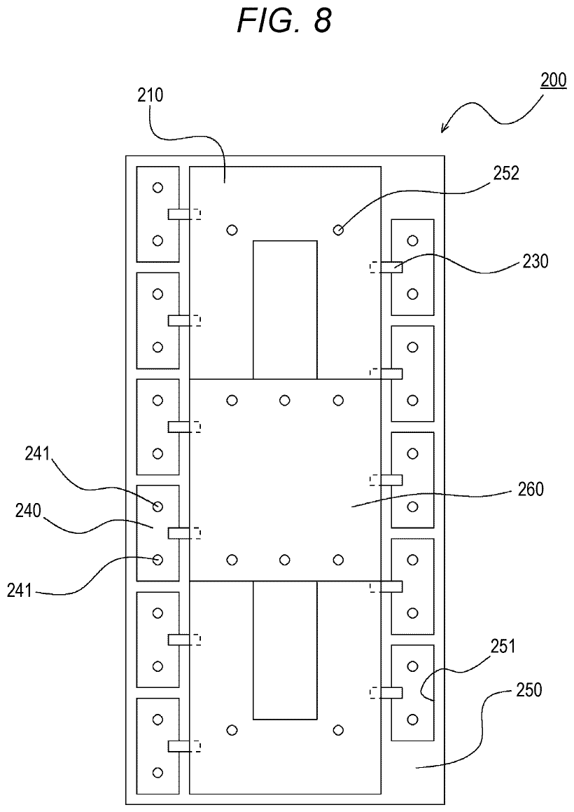

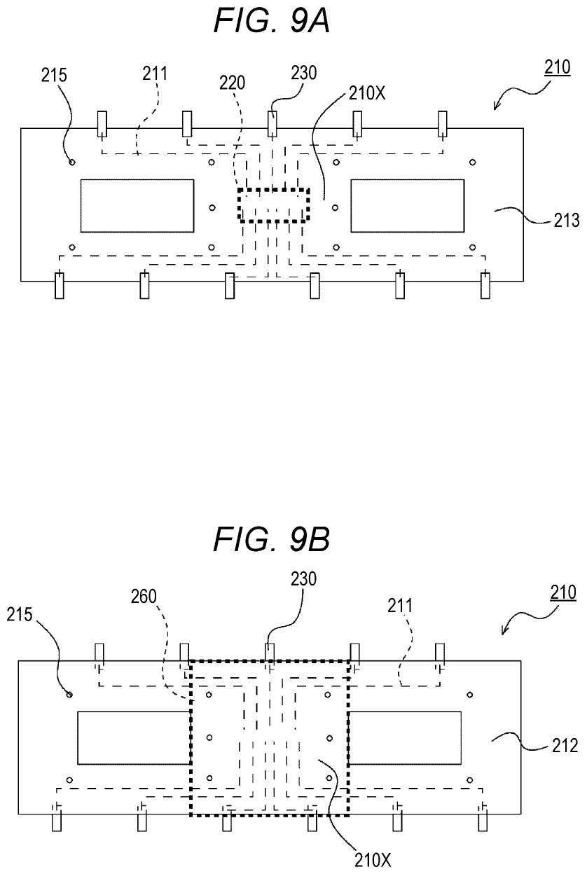

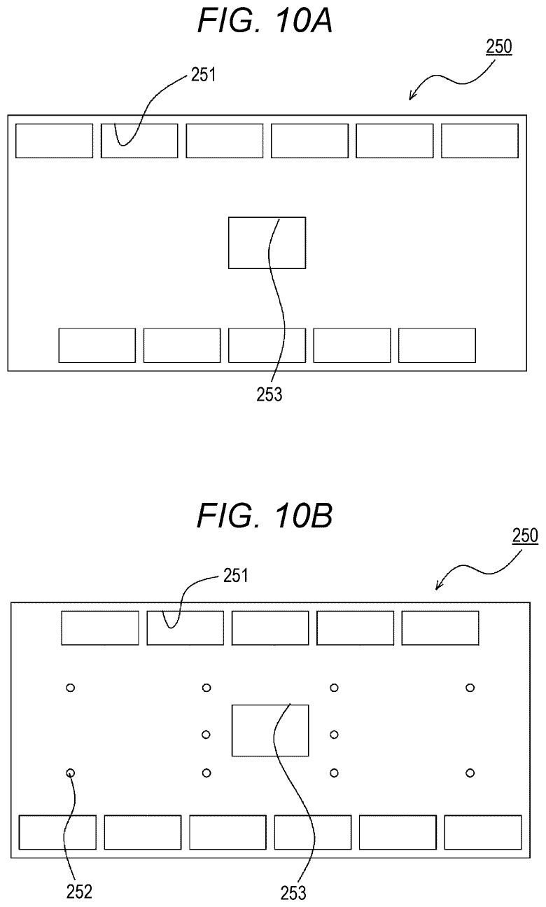

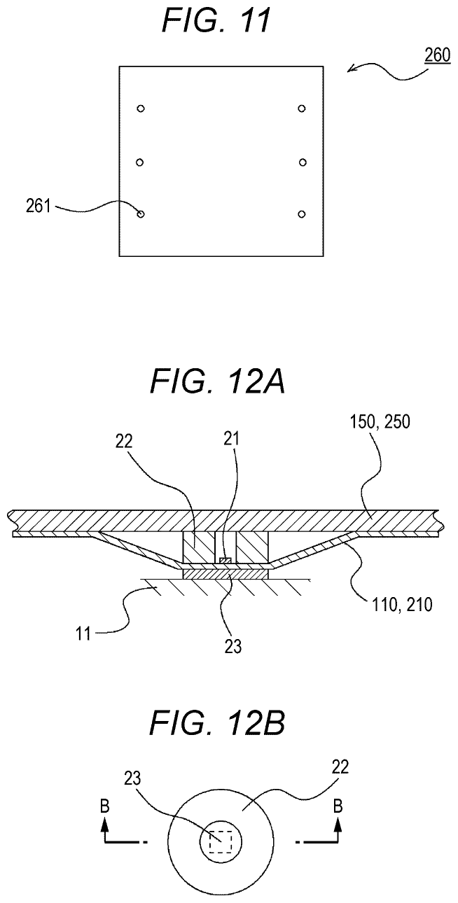

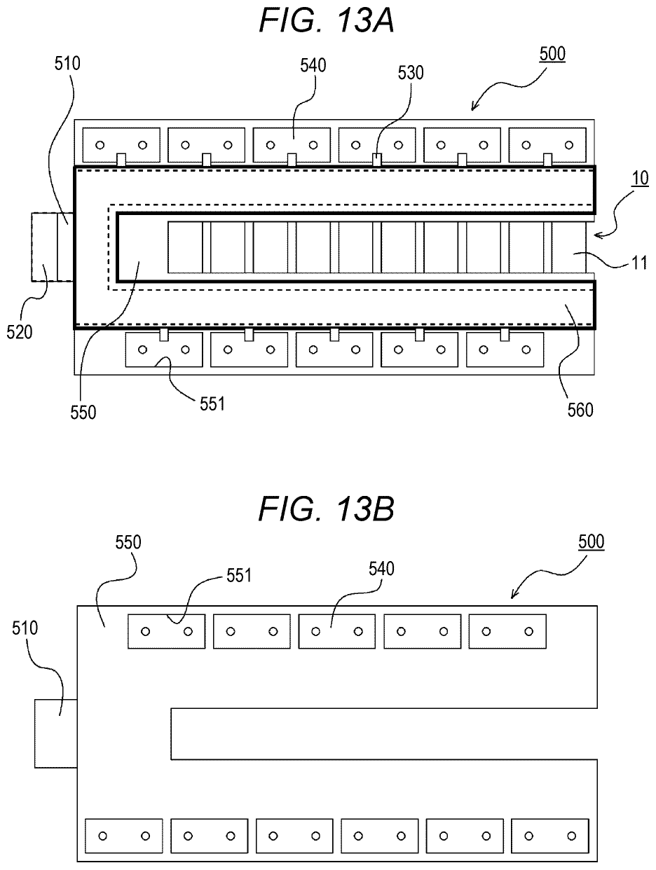

With reference to FIGS. 7A to 11, an FPC module and a battery device according to a second embodiment of the present disclosure will be described. In the description of the first embodiment above, the configuration in the case where the connector is provided at the end portion of the FPC is described. On the other hand, in the description of the second embodiment, a configuration in a case where a connector is provided at the center of an FPC will be described. FIGS. 7A and 7B are schematic views of the battery device according to the second embodiment, and FIG. 7A is a plan view of the battery device. FIG. 7B is a side view of the battery device. FIG. 8 is a bottom view of the FPC module according to the second embodiment. FIGS. 9A and 9B are schematic views of the FPC and the like used in the second embodiment. FIG. 9A is a plan view of the FPC and the like. FIG. 9B is a bottom view of the FPC and the like. FIGS. 10A and 10B are schematic views of a case used in the second embodiment. FIG. 10A is a plan view of the case. FIG. 10B is a bottom view of the case. FIG. 11 is a plan view of a reinforcing plate used in the second embodiment.

### <Outline of Battery Device>

As shown in FIG. 7B, the battery device includes the battery 10 having the plurality of cells 11, and an FPC module 200 attached to the battery 10. The FPC module 200 is used for monitoring the voltage of the cell 11. The configuration of the battery 10 is as described in the first embodiment. Thus, the description of this configuration will be omitted here.

### <FPC Module>

The FPC module 200 includes an FPC 210. The FPC 210 includes a plurality of lines 211, and resin films (base film 212 and cover film 213) provided on the upper and lower surfaces of the plurality of lines 211. In FIGS. 9A and 9B, the lines 211 are see-through, and are indicated by dotted lines. The outer shape of the FPC 210 used in the second embodiment is a rectangular annular shape. Further, the FPC 210 is provided with a closure 210X for closing an opening 253 formed in a case 250 described later. A connector 220 is disposed in the opening 253, and is attached to the closure 210X described above. In FIG. 9A, a portion to which the connector 220 is attached is indicated by a thick dotted line. A corresponding connection terminal 230 is attached to each of the plurality of lines 211 of the FPC 210 (see FIG. 9A). Note that an opening is provided in part of the cover film 213, and therefore, the connector 220 and each connection terminal 230 are joined to the lines 211, for example, by soldering. Moreover, the connector 220 is connected to an external device (ECU or the like) for monitoring the voltage of the cell 11.

The FPC module 200 includes a plurality of bus bars 240 and a resin case 250. The bus bar 240 is indirectly and electrically connected to the line 211 of the FPC 210 via the connection terminal 230. The FPC 210 and the plurality of bus bars 240 are attached to the case 250. The connection terminal 230 and the bus bar 240 are joined to each other, for example, with solder. As described in the first embodiment, the bus bar 240 and the cells 11 (positive electrode 11a and negative electrode 11b) are joined to each other by welding. The welding method and the welding direction are as described in the first embodiment. S in FIG. 7B indicates a welded portion. Also in the second embodiment, the bus bar 240 is provided with a through-hole 241 in order to easily recognize a welding position. Note that the through-hole 241 is not necessarily provided.

A plurality of attachment holes 251 is provided in the case 250. The bus bar 240 is fixed in each of these attachment holes 251. As well as the first embodiment, a method for fixing the attachment hole 251 and the bus bar 240 to each other is not particularly limited. Various well-known techniques may be adopted. The FPC 210 is fixed to the case 250 at a plurality of positions by thermal caulking. In the second embodiment, the case 250 is provided with a plurality of protrusions 252 for the thermal caulking. Further, the FPC 210 is provided with a plurality of insertion holes 215. The protrusion 252 penetrates the insertion hole 215. With this configuration, the thermal caulking can be performed in a state of the protrusion 252 being inserted into the insertion hole 215. In this manner, the FPC 210 can be fixed to the case 250. As described in the first embodiment, a reinforcing plate having a higher stiffness than that of the FPC 210 can be bonded. In this manner, the FPC 210 can be more easily fixed to the case 250. Note that the reinforcing plate may be a resin film. Alternatively, the reinforcing plate may be, for example, a less-bendable resin board. In the second embodiment, a reinforcing plate 260 is provided at a position at which the connector 220 is attached, so that the connector 220 can be properly attached. In FIG. 9B, the position at which the reinforcing plate 260 is fixed is indicated by a thick dotted line. Hereinafter, this point will be described in more detail. Note that a reinforcing plate may be provided at a position other than the position at which the connector 220 is attached, needless to say.

The outer shape of the case 250 used in the second embodiment is a rectangular annular shape. The center of the case 250 is provided with the opening 253 (see FIGS. 10A and 10B). As described above, the FPC 210 has the closure 210X for closing the opening 253 (see FIGS. 7A, 9A, and 9B). The FPC module 200 according to the second embodiment includes the reinforcing plate 260 having a higher strength than that of the FPC 210. The reinforcing plate 260 is fixed to the case 250 via the FPC 210 while covering the closure 210X of the FPC 210 (see FIG. 8). The reinforcing plate 260 is provided with a through-hole 261. A protrusion 252 for thermal caulking, which is provided for the case 250, is inserted into the through-hole 261 (see FIG. 11). Note that for example, a less-deformable resin board can be suitably used as the reinforcing plate 260. In this manner, the connector 220 used in the second embodiment is connected to the closure 210X. The reinforcing plate 260 is provided on the opposite side of the FPC 210 from the connector 220. Thus, the connector 220 can be attached to the FPC 210 without loosening of the FPC 210 (closure 210X).

Note that as also described in the first embodiment, a method for fixing the case 250 and the FPC 210 to each other is not limited to the thermal caulking. Various well-known techniques such as fixing with a gluing agent, an adhesive, or a double-sided tape may be adopted.

In the FPC module 200 configured as described above, the plurality of bus bars 240 is joined to the battery 10 (cells 11) by welding in a state in which the FPC 210 fixed to the case 250 faces the battery 10. The welding direction and the like are as described in the first embodiment. In the second embodiment, the FPC 210 is also disposed between the battery 10 and the case 250.

### <Advantages of FPC Module and Battery Device According to Second Embodiment>

According to the second embodiment, as well as the first embodiment, the FPC 210 is disposed between the battery 10 and the case 250. Thus, the FPC 210 is covered with the case 250 (see FIG. 7). Thus, even if sputtering occurs when the bus bar 240 is welded to the cells 11, collision of sputtered particles with the FPC 210 can be reduced by the case 250. That is, the effect similar to the first embodiment can be exerted. Further, also in the second embodiment, when the FPC module 200 is attached to the battery 10, the FPC 210 faces downward of the case 250. However, the FPC 210 is fixed to the case 250. This prevents the FPC 210 from hanging down. Further, similarly to the first embodiment, in the second embodiment, adherence of a contaminant, such as dirt or dust, to an electronic component disposed on the FPC can also be reduced. Note that although not particularly shown in the figure, the case 250 is preferably provided with a hole for forming a closed space where the electronic component is disposed, as described in the first embodiment.

In the configuration adopted in the second embodiment, the reinforcing plate 260 is provided to cover the closure 210X of the FPC 210. The connector 220 is attached to the closure 210X. With this configuration, the connector 220 can be attached without loosening of the closure 210X or damage thereto when the connector 220 is attached.

### Third Embodiment

With reference to FIGS. 12A and 12B, an FPC module and a battery device according to a third embodiment will be described. In the description of the third embodiment, the configurations of the FPC modules and the battery devices of the first and second embodiments above having also a temperature measurement function will be described. FIGS. 12A and 12B are schematic views of the FPC module according to the third embodiment. FIG. 12A is a schematic sectional view of the FPC module. FIG. 12B is a plan view of an elastic body. Note that the sectional view of the elastic body of FIG. 12A corresponds to a sectional view taken along BB line in FIG. 12B. Moreover, in FIGS. 12A and 12B, the same components as those described in the first or second embodiment are denoted by the same reference numerals.

The FPC module according to the third embodiment includes a thermistor element 21 and an elastic body 22. The thermistor element 21 is electrically connected to the line of the FPC 110 or the FPC 210. The thermistor element 21 is interposed between the case 150 and the FPC 110 or between the case 250 and the FPC 210. On the FPC 110 or the FPC 210, a contact plate 23 contacting the cell 11 is provided on the opposite side of the FPC 110 or the FPC 210 from the thermistor element 21. The contact plate 23 is formed of, for example, a plate made of a high-thermal-conductivity material such as aluminum. The contact plate 23 is bonded to the FPC 110 or the FPC 210, for example, with an adhesive or a double-sided tape.

As described above, the configuration adopted in the third embodiment is provided with the thermistor element 21. Thus, not only the voltage of the cell 11 but also the temperature of the cell 11 can be monitored. Note that generally for a battery, the voltages of all cells are monitored. On the other hand, the temperatures of all the cells are not necessarily monitored. Thus, a proper number of the thermistor elements 21 are provided according to the number of cells 11 of the battery 10 or use environment.

The elastic body 22 is made of, for example, a foam material such as foamed rubbers or foamed urethanes. In the configuration of the third embodiment, the elastic body 22 is formed in a cylindrical shape. Further, the thermistor element 21 is provided in such a cylinder. In FIG. 12B, the position of the thermistor element 21 in the cylinder is indicated by a dotted line. Note that the elastic body 22 and the FPC 110 can be bonded using an adhesive or a double-sided tape, and the elastic body 22 and the case 150 can be bonded using an adhesive or a double-sided tape. Similarly, the elastic body 22 and the FPC 210 can be bonded using an adhesive or a double-sided tape, and the elastic body 22 and the case 250 can be bonded using an adhesive or a double-sided tape.

As described above, in the third embodiment, the thermistor element 21 that measures the temperature of the cell 11 and the elastic body 22 are disposed between the case 150 and the FPC 110 or between the case 250 and the FPC 210. Further, in the third embodiment, the FPC module 100, 200 is disposed on the battery 10 such that the FPC 110, 210 fixed to the case 150, 250 faces the battery 10. Thus, as described above, the thermistor element 21 and the elastic body 22 can be provided between the case 150, 250 and the FPC 110, 210. That is, only by providing the thermistor element 21 and the elastic body 22 between the case 150, 250 and the FPC 110, 210, the FPC 110, 210 can be pressed toward the cell 11 with the elastic force of the elastic body 22 when the FPC module 100, 200 is attached to the battery 10. In this manner, the contact plate 23 can closely contact the cell 11. Thus, unlike a general technique, the structure for measuring the temperature of the cell 11 can be achieved without a complicated structure. Thus, the case 150 and the case 250 can be reduced in size.

The foregoing detailed description has been presented for the purposes of illustration and description. Many modifications and variations are possible in light of the above teaching. It is not intended to be exhaustive or to limit the subject matter described herein to the precise form disclosed. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims appended hereto.

What is claimed is:

1. A flexible printed circuit board module attachable to a battery including a plurality of cells, comprising:
a flexible printed circuit board;
a plurality of bus bars; and
a case,
wherein the flexible printed circuit board includes a line,
the plurality of bus bars is electrically connected to the line,
the flexible printed circuit board and the plurality of bus bars are attached to the case, and
the flexible printed circuit board is disposed between the battery and the case.

2. The flexible printed circuit board module according to claim 1, wherein
the case is provided with a plurality of attachment holes,
each of the plurality of bus bars is fixed to a corresponding one of the plurality of attachment holes, and
the flexible printed circuit board is fixed to the case at a plurality of positions by thermal caulking.

3. The flexible printed circuit board module according to claim 1, further comprising:
a reinforcing plate; and
a connector,
wherein the case is formed with an opening,
the flexible printed circuit board includes a closure closing the opening,
the reinforcing plate is fixed to the case via the flexible printed circuit board while covering the closure, and has a higher strength than that of the flexible printed circuit board, and
the connector is disposed in the opening, and is attached to the closure.

4. The flexible printed circuit board module according to claim 1, wherein
a thermistor element that measures a temperature of each cell is disposed between the case and the flexible printed circuit board.

5. The flexible printed circuit board module according to claim 2, wherein
a thermistor element that measures a temperature of each cell is disposed between the case and the flexible printed circuit board.

6. The flexible printed circuit board module according to claim 3, wherein
a thermistor element that measures a temperature of each cell is disposed between the case and the flexible printed circuit board.

7. A battery device comprising:
a battery having a plurality of cells; and
a flexible printed circuit board module attached to the battery,
wherein the flexible printed circuit board module includes a flexible printed circuit board, a plurality of bus bars and a case,
the flexible printed circuit board includes a line,
the plurality of bus bars is electrically connected to the line,
the flexible printed circuit board and the plurality of bus bars are attached to the case, and
the flexible printed circuit board is disposed between the battery and the case.
